(19) United States
(12) Patent Application Publication
(10) Pub. No.: US 2007/0057901 A1
(43) Pub. Date: Mar. 15, 2007

(54) ELECTRO-OPTICAL DEVICE AND ELECTRONIC APPARATUS

(75) Inventor: Eiji Chino, Azumino (JP)

Correspondence Address: HARNESS, DICKEY & PIERCE, P.L.C., P.O. BOX 828, BLOOMFIELD HILLS, MI, 48303, US

(73) Assignee: SANYO EPSON IMAGING DEVICES CORP., Tokyo (JP)

(21) Appl. No.: 11/460,083

(22) Filed: Jul. 26, 2006

(30) Foreign Application Priority Data
Sep. 9, 2005 (JP) 2005-261693
Oct. 18, 2005 (JP) 2005-302744

(51) Int. Cl. G09G 3/36

(52) U.S. Cl. 345/102

(57) ABSTRACT

An electro-optical device includes: a liquid crystal panel that includes display pixels each having a plurality of sub-pixels; and an illuminating device that illuminates the liquid crystal panel. In the electro-optical device, the plurality of sub-pixels include at least two cyan and white sub-pixels.

### BACKGROUND

1. Technical Field

The present invention relates to an electro-optical device suitable for displaying various information items.

2. Related Art

An electro-optical device including a liquid crystal display device displays a color image by using an illuminating device that emits white light and red (R), green (G), and blue (B) color filters. The reproduction range of colors that the electro-optical device can display is limited to a triangular color region on a chromaticity diagram that is defined by R, G, and B color filters. In general, in the color reproduction range defined by the triangular color region, cyan has low chromaticity, and thus it is difficult to obtain sufficient color reproducibility. In liquid crystal display devices disclosed in JP-A-2001-306023 and JP-A-2002-286927, one display pixel is divided into four or six sub-pixels, and the sub-pixels have R, G, B, and C color filters.

In recent years, there has been proposed a liquid crystal display device including display pixels each having R, G, B, and W (transparent) sub-pixels. A liquid crystal display device disclosed in JP-A-2003-295812 improves the brightness of the entire display screen by using the W sub-pixels.

However, in the liquid crystal display devices disclosed in JP-A-2001-306023 and JP-A-2002-286927, one display pixel is divided into three sub-pixels, that is, R, G, and B sub-pixels, or it is divided into four or six sub-pixels. Therefore, as compared with a general liquid crystal display device having only R, G, and B color filter, the aperture ratio of one sub-pixel is low in the disclosed liquid crystal display devices, which causes the transmittance of light and the brightness of a display screen to be lowered. In the liquid crystal display device disclosed in JP-A-2003-295812, the addition of the W sub-pixel enables an improvement in the brightness of the display screen, but the color reproduction range is limited to the triangular color region defined by the R, G, and B color filters.

### SUMMARY

An advantage of some aspects of the invention is that it provides an electro-optical device capable of widening the color reproduction range and improving the brightness.

According to an aspect of the invention, an electro-optical device includes: a liquid crystal panel that includes display pixels each having a plurality of sub-pixels; and an illuminating device that illuminates the liquid crystal panel. In the electro-optical device, the plurality of sub-pixels include at least cyan (c) and white (W) sub-pixels. In addition, it is preferable that the plurality of sub-pixels further include red (R), blue (B), and green (G) sub-pixels.

According to another aspect of the invention, an electro-optical device includes: a liquid crystal panel that includes display pixels each having a plurality of sub-pixels; and an illuminating device that illuminates the liquid crystal panel. In the electro-optical device, at least two of the plurality of sub-pixels have regions colored in two colors selected from a color range from blue to yellow, and at least one of the plurality of sub-pixels has a region that transmits light without coloring. Further, in the electro-optical device according to this aspect, preferably, the plurality of sub-pixels further include a sub-pixel having a region colored in a shade of blue and a sub-pixel having a region colored in a shade of red.

In the electro-optical device according to this aspect, preferably, one of the two sub-pixels has a region colored in one color selected from a color range from blue to green, and the other sub-pixel has a region colored in one color selected from a color range from green to orange.

According to still another aspect of the invention, an electro-optical device includes a liquid crystal panel that includes display pixels each having a plurality of sub-pixels; and an illuminating device that illuminates the liquid crystal panel. In the electro-optical device, the plurality of sub-pixels include a sub-pixel having a colored region that transmits light having a peak wavelength of 485 to 535 nm, a sub-pixel having a colored region that transmits light having a peak wavelength of 500 to 590 nm, and a sub-pixel having a region that transmits light without coloring. Further, in the electro-optical device according to this aspect, preferably, the plurality of sub-pixels further include a sub-pixel having a colored region that transmits light having a peak wavelength of 415 to 500 nm and a sub-pixel having a colored region that transmits light having a peak wavelength larger than 600 nm.

In the electro-optical device according to this aspect, the plurality of sub-pixels include a sub-pixel having a colored region that transmits light having a peak wavelength of 495 to 520 nm and a sub-pixel having a colored region that transmits light having a peak wavelength of 510 to 585 nm.

According to the above-mentioned aspect, the electro-optical device is, for example, a liquid crystal display device, and includes a liquid crystal display panel and an illuminating device. The illuminating device includes a light source, such as an LED, and light emitted from the light source is incident on the liquid crystal display panel. The liquid crystal display panel includes display pixels each having five sub-pixels, that is, a red (R) sub-pixel, a green (G) sub-pixel, a blue (B) sub-pixel, a cyan (C) sub-pixel, and a transparent (W) sub-pixel. The use of the C sub-pixel makes it possible to widen the color reproduction range and to prevent a reduction in the brightness of green (G) having high visibility. The use of the W sub-pixel makes it possible to prevent a reduction in the brightness of the entire display screen due to an increase in the number of sub-pixels divided from one display pixel.

According to yet another aspect of the invention, an electro-optical device includes a display panel and an illuminating device. The illuminating device includes a light source, such as an LED, and light emitted from the light source is incident on the display panel. The display panel includes display pixels each having five sub-pixels. The five sub-pixels are composed of four sub-pixels having, within a visible light range where a color varies according to a waveform, a region colored in a shade of blue, a region colored in a shade of red, and two regions colored in two colors selected from a color range from blue to yellow, and a sub-pixel having a white region. The use of the five sub pixels makes it possible to widen the color reproduction range and to prevent a reduction in the brightness of light. The use of the sub-pixel having the white region makes it possible to prevent a reduction in the brightness of the entire display screen due to an increase in the number of sub-pixels divided from one display pixel.

According to the above-mentioned aspect, preferably, the electro-optical device further includes a display image converting circuit that converts input R, G, and B image signals into R, G, B, and C image signals corresponding to the plurality of sub-pixels. In this way, even when R, G, and B image signals are input as image signals of an input image, it is possible to widen the color reproduction range of an output image to the color reproduction range of a shade of cyan. More specifically, the display image converting circuit obtains R, G, B, and C image signals corresponding to the input R, G, and B image signals from a look up table (LUT), and outputs the obtained image signals to the liquid crystal panel, which makes it possible to improve the color purity of an output image.

In the electro-optical device according to this aspect, preferably, the display image converting circuit calculates a brightness signal from input R, G, and B image signals and determines an image signal corresponding to the sub-pixel having the white region that transmits the light without coloring, on the basis of the brightness signal.

In the electro-optical device according to this aspect, preferably, the display image converting circuit determines the brightness of the illuminating device on the basis of the brightness signal and adjusts the brightness of the illuminating device. In this way, it is possible to improve the contrast of a display screen.

According to yet still another aspect of the invention, an electronic apparatus includes, as a display unit, the above-mentioned electro-optical device.

### BRIEF DESCRIPTION OF THE DRAWINGS

The invention will be described with reference to the accompanying drawings, wherein like numbers refer to like elements.

FIG. 1 is a plan view illustrating a liquid crystal display device according to a first embodiment of the invention.

FIG. 2 is a cross-sectional view of the liquid crystal display device according to the first embodiment.

FIGS. 3A and 3B are plan views illustrating a sub-pixel of the liquid crystal display device according to the first embodiment.

FIG. 4 is a graph illustrating a spectral distribution of the liquid crystal display device according to the first embodiment.

FIG. 5 is a CIE (Commission Internationale de l'Eclairage) xy chromaticity diagram illustrating a chromaticity range.

FIG. 6 is a diagram schematically illustrating the liquid crystal display device according to the first embodiment.

FIG. 7 is a diagram schematically illustrating a liquid crystal display device according to a second embodiment of the invention.

FIG. 8 is a diagram schematically illustrating a liquid crystal display device according to a third embodiment of the invention.

FIGS. 9A to 9D are plan views illustrating sub-pixels of liquid crystal display devices according to modifications of the above-mentioned embodiments of the invention.

FIGS. 10A and 10B are perspective views illustrating electronic apparatuses to which the liquid crystal display devices according to the above-mentioned embodiments of the invention are applied.

### DESCRIPTION OF EXEMPLARY EMBODIMENTS

Hereinafter, preferred embodiments of the invention will be described below with reference to the accompanying drawings.

### First Embodiment

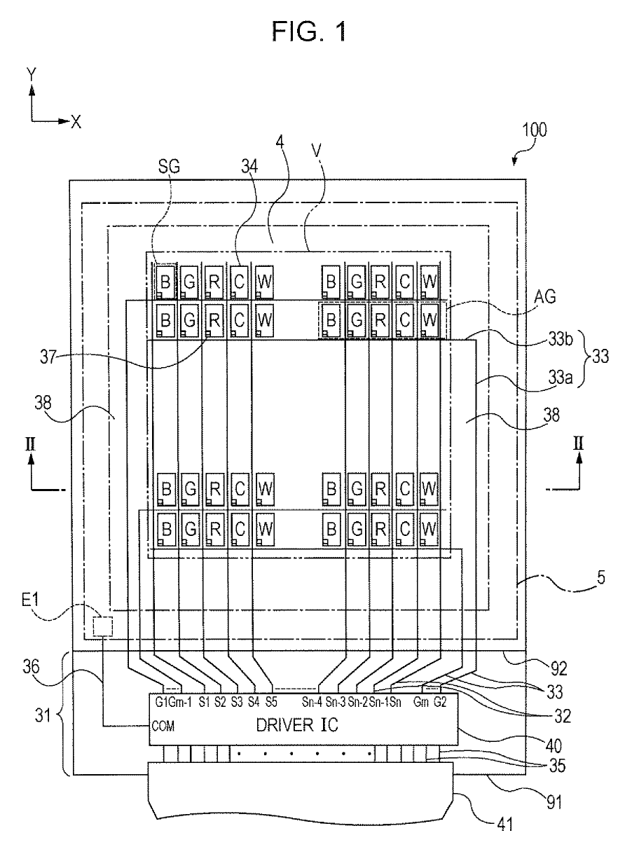

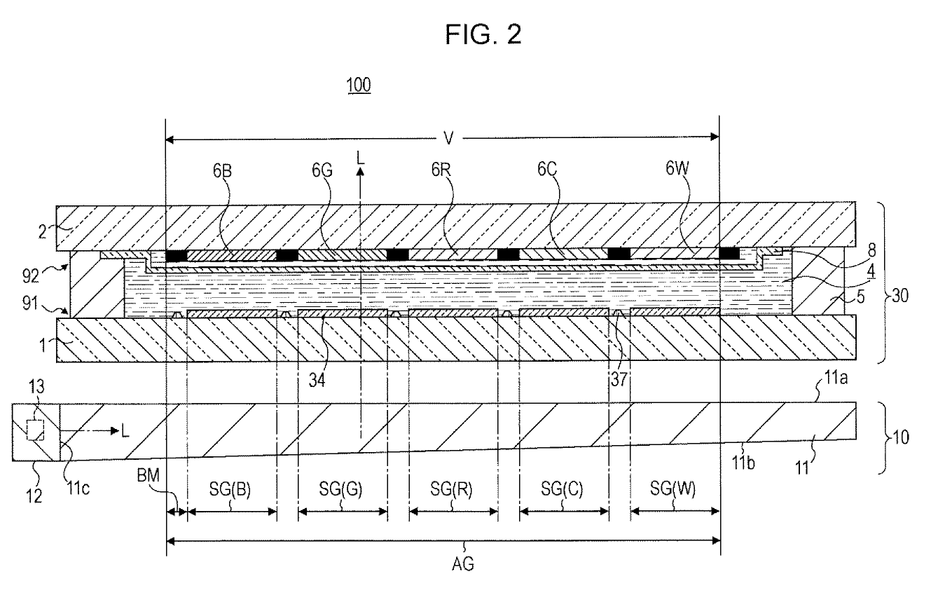

First, the structure of a liquid crystal display device 100 according to a first embodiment of the invention will be described with reference to FIGS. 1 and 2.

FIG. 1 is a plan view schematically illustrating the structure of the liquid crystal display device 100 according to the first embodiment. In FIG. 1, a color filter substrate 92 is arranged on the front surface (on the observer side) of the drawing, and an element substrate 91 is arranged on the rear side of the drawing. In FIG. 1, it is assumed that a longitudinal direction is referred to as a Y direction and a lateral direction is referred to as an X direction. In addition, in FIG. 1, R (red), G (green), B (blue), C (cyan), and W (transparent or white) regions are represented by sub-pixels SG, and a row of R, G, B, C, and W sub-pixels SG corresponds to a display pixel AG.

FIG. 2 is an enlarged cross-sectional view of the display pixel AG taken long the line II-II of the liquid crystal display device 100 shown in FIG. 1. As shown in FIG. 2, the liquid crystal display device 100 includes a liquid crystal display panel 30 and an illuminating device 10. The liquid crystal display panel 30 includes the element substrate 91, the color filter substrate 92 arranged opposite to the element substrate 91, a frame-shaped sealing member 5 for bonding the two substrates 91 and 92, and a liquid crystal layer 4 that is composed of liquid crystal injected into the sealing member 5. The illuminating device 10 for illuminating the liquid crystal display panel 30 is provided on an outer surface of the element substrate 91 of the liquid crystal display panel 30.

The liquid crystal display device 100 according to the first embodiment displays a color image using five colors, R, G, B, C, and W, and is driven by an active matrix driving method using a-Si thin film transistors (TFTs) as switching elements.

Next, the plan-view structure of the element substrate 91 will be described below. For example, the element substrate 91 has a plurality of source lines 32, a plurality of gate lines 33, a plurality of a-Si TFTs 37, a plurality of pixel electrodes 34, a driver IC 40, a plurality of external connection wiring lines 35, and a flexible printed circuit (FPC) 41 formed or mounted on an inner surface thereof.

As shown in FIG. 1, the element substrate 91 has a projecting region 31 that protrudes from a side of the color filter substrate 92 to the outside, and the driver IC 40 is mounted on the projecting region 31. Input terminals (not shown) of the driver IC 40 are electrically connected to one end of each of the plurality of external connection wiring lines 35, and the other ends of the plurality of external connection wiring lines 35 are electrically connected to the FPC 41. The source lines 32 extend in the Y direction at predetermined intervals in the X direction, and one end of each of the source lines 32 is electrically connected to output terminals (not shown).

Each of the gate lines 33 is composed of a first wiring line 33a extending in the Y direction and a second wiring line 33b curved in the X direction at the end of the first wiring line 33a. The second wiring lines 33b of the gate lines 33 are formed so as to intersect the source lines 32, that is, to extend in the X direction, and to be arranged at predetermined intervals in the Y direction. One end of each of the first wiring lines 33a of the gate lines 33 is electrically connected to the output terminal (not shown) of the driver IC 40. The a-Si TFTs 37 are provided so as to correspond to intersections of the second wiring lines 33b of the gate lines 33 and the source lines 32, and are electrically connected to, for example, the source lines 32, the gate lines 33, and pixel electrodes 34. The a-Si TFTs 37 and the pixel electrodes 34 are provided at positions corresponding to the sub-pixels SG on a substrate 1 formed of, for example, glass. The pixel electrodes 34 are formed of a transparent conductive material, such as indium-tin oxide (ITO).

A region where a plurality of display pixels AG are arranged in the X and Y directions in a matrix is an effective display region V (a region surrounded by a two-dotted chain line). Images, such as characters, figures, and numbers, are displayed in the effective display region V. That is, the effective display region V indicates a display screen region of the liquid crystal display device 100. A frame region 38 which does not contribute to display is arranged outside the effective display region V. An alignment film (not shown) is formed on the inner surfaces of the source lines 32, the gate lines 33, the a-Si TFTs 37, and the pixel electrodes 34.

Next, the plan-view structure of the color filter substrate 92 will be described below. As shown in FIG. 2, the color filter substrate 92 has a light-shielding layer (which is generally called a ‘black matrix’ and is simply referred to as ‘BM’), R, G, B, and C colored layers 6R, 6G, 6B, and 6C, transparent or white portions 6W, and a common electrode 8 formed on a substrate 2 formed of, for example, glass. The transparent or white portion 6W is formed of a transparent resin, or no layer is formed therein, so that light L emitted from the illuminating device 10 passes through the portion without being colored. The BM is formed so as to partition the sub-pixels SG. In FIG. 2, colors corresponding to the sub-pixels SG are put in parentheses. Further, in the following description or drawings, when R, G, B, and C colored layers are described without discriminating the colors thereof, the R, G, B, and C colored layers are simply described as ‘colored layers 6’. On the other hand, when the R, G, B, and C colored layers need to be discriminated from each other, the colored layers are represented by ‘a colored layer 6R’, ‘a colored layer 6G’, ‘a colored layer 6B’, and ‘a colored layer 6C’. The colored layers 6R, 6G, 6B, and 6C and the transparent or white portion 6W form a color filter. The common electrode 8 is formed of a transparent conductive material, such as ITO, similar to the pixel electrodes, and is formed on one surface of the color filter substrate 92. The common electrode 8 is electrically connected to one end of a wiring line 36 in a corner E1 of the sealing member 5, and the other end of the wiring line 36 is electrically connected to an output terminal COM of the driver IC 40.

Next, the illuminating device 10 will be described below. The illuminating device 10 includes an optical waveguide 11 and a light source unit 12. The light source unit 12 includes a plurality of light-emitting diodes (LEDs) 13 serving as a light source. Any of the following arrays may be used as the plurality of LEDs 13: a single-chip-type array of white LEDs that emits white light by exciting a YAG (yttrium aluminum garnet)-based fluorescent material by using blue light emitted from a blue LED; and a multi-chip-type array of LEDs that emits white light by making R, G, and B LEDs emit light beams at the same time and by mixing the light beams. White light emitted from the plurality of LEDs 13 is emitted toward a side surface (hereinafter, referred to as an ‘incident surface’) 11c of the optical waveguide 11 as the light L emitted from the light source unit 12.

The light L emitted from the light source unit 12 is introduced into the optical waveguide 11 through the incident surface 11c of the optical waveguide 11, and travels therein while being repeatedly reflected from an emission surface 11a and a reflective surface 11b of the optical waveguide 11. Then, when an angle formed between the emission surface 11a of the optical waveguide 11 and the light L exceeds a predetermined threshold angle, the light L is emitted from the emission surface 11a of the optical waveguide 11 to the liquid crystal display panel 30 through an optical sheet (not shown). The liquid crystal display device 100 is illuminated by the light L passing through the liquid crystal display panel 30. In this way, the liquid crystal display device 100 can display images, such as characters, numbers, and figures, and thus a viewer can view the images.

The illuminating device 10 has the LED 13 as a light source of the light source unit 12, but the invention is not limited thereto. For example, the illuminating device 10 may have light sources other than the LED, such as a fluorescent tube, an organic electroluminescent element, and a white light source as long as it can emit R, G, and B light beams. It is preferable that the R, G, and B light sources have the following characteristics:
(1) The peak wavelength of a B light beam is in the range of 435 nm to 485 nm;
(2) The peak wavelength of a G light beam is in the range of 520 nm to 545 nm; and
(3) The peak wavelength of an R light beam is in the range of 610 nm to 650 nm.

When the color filers are suitably selected, the wavelengths of the R, G, and B light sources make it possible to obtain wider color reproducibility. For example, a light source having a plurality of peak wavelengths in the range 450 nm to 565 nm may be used.

In the liquid crystal display device 100, on the basis of signals and power supplied from the FPC 41 connected to a main board of an electronic apparatus, the driver IC 40 sequentially and exclusively selects the gate lines 33 in the order of G1, G2, G3, . . . , Gm−1, Gm (m is a natural number). In addition, a gate signal having a selection voltage is supplied to the selected gate line 33, and a gate signal having a non-selection voltage is supplied to non-selected gate lines 33. The driver IC 40 supplies source signals corresponding to display content to the pixel electrodes 34 corresponding to the selected gate line 33 through the source lines 32 (S1, S2, . . . , Sn−1, Sn (n is a natural number)) and the a-Si TFTs 37. As a result, the alignment state of the liquid crystal layer 4 is controlled, and the display state of the liquid crystal display device 100 is switched from a non-display state to a halftone display state.

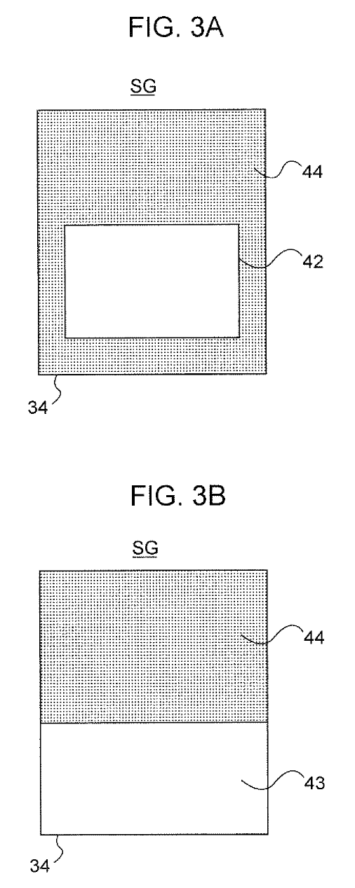

The liquid crystal display device 100 of a transmissive type has been described above, but the invention is not limited thereto. For example, a transflective liquid crystal display device may be used. FIGS. 3A and 3B show the structure of a sub-pixel SG of the transflective liquid crystal display device. In this case, a reflective layer 44 for reflecting light is provided on the pixel electrode 34 of each sub-pixel SG. As an example of the structure, as shown in FIG. 3A, an aperture 42 is provided in the reflective layer 44. The aperture 42 serves as a transmissive region for transmitting the light L emitted from the illuminating device 10. As shown in FIG. 3B, the sub-pixel SG may be divided into two regions, the reflective layer 44 may be formed on only one of the two regions, and no reflective layer 44 may be formed on the other region. In this case, a region 43 where the reflective layer 44 is not formed serves as a transmissive region for transmitting the light L emitted from the illuminating device 10.

As shown in FIG. 1, the a-Si TFTs 37 are used as the switching elements, but the invention is not limited thereto. For example, polysilicon TFTs or TFDs (thin film diodes) may be used as the switching elements.

### Spectral Distribution and Chromaticity Diagram

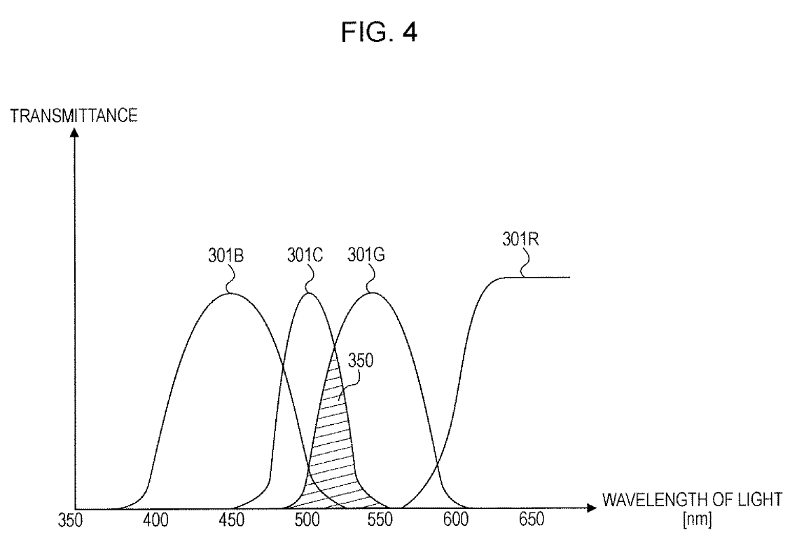

FIG. 4 shows the relationship between the wavelength of light and the transmittance of the colored layer 6 in the liquid crystal display device 100 according to the first embodiment. In FIG. 4, the horizontal axis indicates the wavelength [nm] of light, and the vertical axis indicates the transmittance of the colored layer.

In FIG. 4, graphs 301R, 301G, 301B, and 301C indicate the transmittances of the R, G, B, and C colored layers 6R, 6G, 6B, and 6C, respectively. As can be seen from the graphs 301R, 301G, 301B, and 301C, the R, G, B, and C colored layers 6R, 6G, 6B, and 6C have the maximum transmittances in their wavelength ranges of R, G, B, and C, respectively. Therefore, in the liquid crystal display device according to the first embodiment, when R, G, B, and C are displayed, the R, G, B, and C colored layers transmit only light components in their wavelength ranges, respectively, which makes it possible to display a color image. As can be seen from FIG. 4, the graph 301C has a region 350 overlapping the graph 301G. That is, the C colored layer 6C and the G colored layer 6G have an overlapping transmission wavelength range.

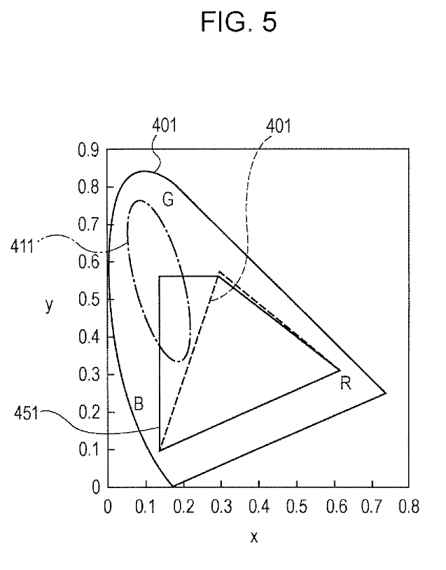

FIG. 5 is a CIE chromaticity diagram (xy chromaticity diagram) illustrating the color reproduction range of the liquid crystal display device according to the first embodiment. In FIG. 5, a color reproduction range 401 is a color reproduction range according to the wavelength sensitivity characteristic of human eye, and also indicates a color reproduction range that is sensible by the human eye. A triangular color reproduction range 402 represented by a dashed line is obtained by a general liquid crystal display device having only R, G, and B colored layers. Meanwhile, a rectangular color reproduction range 451 represented by a solid line is obtained by the liquid crystal display device 100 according to the first embodiment. A color reproduction range 411 indicates a color reproduction range of a shade of cyan.

In FIG. 5, as can be seen from the cyan-based color reproduction range 411, since the general liquid crystal display device having only the R, G, and B colored layers has the color reproduction range 402, it is difficult for the general liquid crystal display device to display a cyan-based color. In contrast, the color reproduction range 451 obtained by the liquid crystal display device according to the first embodiment is wider than the color reproduction range 402, and in particular, protrudes to the cyan-based color reproduction range 411. That is, the liquid crystal display device according to the first embodiment makes it possible to widen the color reproduction range, particularly, the cyan-based color reproduction range.

As compared with the general liquid crystal display device having only the R, G, and B colored layers, in the liquid crystal display device according to the first embodiment, in addition to R, G, and B sub-pixels SG, C and W sub-pixels SG are provided in one display pixel. In the general liquid crystal display device having only the R, G, and B colored layers, one display pixel is divided into three portions, that is, R, G, and B sub-pixels. In contrast, in the liquid crystal display device according to the first embodiment, one display pixel is divided into five portions, that is, R, G, B, C, and W sub-pixels. Therefore, in the liquid crystal display device 100 according to the first embodiment, when viewed from the entire display screen, the BM formed at positions where the sub-pixels are partitioned increases, and an aperture ratio of each sub-pixel SG is reduced, resulting in low transmittance and brightness, compared with the general liquid crystal display device having only the R, G, and B colored layers.

However, as described above, in the liquid crystal display device according to the first embodiment, the transmission wavelength range of the C colored layer 6C partially overlaps the transmission wavelength range of the G colored layer 6G. Light in the overlapping transmission wavelength range can pass through both the colored layer 6C and the colored layer 6G. That is, in this embodiment, one display pixel is divided into five sub-pixels, which causes the transmittance of light passing through one sub-pixel SG to be smaller than the transmittance of light passing through one sub-pixel in the general liquid crystal display device having only the R, G, and B colored layers. However, in this case, light in the overlapping transmission wavelength range can pass through both the sub-pixel SG having the colored layer 6C and the sub-pixel SG having the colored layer 6G. A G colored light component has high visibility. Therefore, it is possible to prevent a reduction in the brightness of the G colored light component having high visibility by making light having a G wavelength range pass through the C sub-pixel SG. In addition, the R sub-pixel is provided between the G sub-pixel and the C sub-pixel. When the G sub-pixel is adjacent to the C sub-pixel, adjacent sub-pixels appear to be green. However, in this embodiment, it is possible to prevent adjacent G and C sub-pixels from appearing to be green.

In the liquid crystal display device according to the first embodiment, one display pixel is divided into five sub-pixels SG including a W sub-pixel SG. Since the W sub-pixel SG has a transparent or white portion 6W, the light L emitted from the illuminating device 10 can pass through the W sub-pixel SG without being absorbed by the transparent or white portion 6W. Therefore, the use of the W sub-pixel SG makes it possible to improve the brightness of a displayed image and thus to improve the brightness of the entire display screen. Thus, in the liquid crystal display device according to the first embodiment, the use of the W sub-pixel SG capable of transmitting the light L makes it possible to prevent a reduction in the brightness of the entire display screen due to the division of one display pixel into five sub-pixels.

That is, in the liquid crystal display device 100 according to the first embodiment, the use of the C sub-pixel SG makes it possible to widen the color reproduction range and to prevent a reduction in the brightness of G light having high visibility, and the use of the W sub-pixel SG makes it possible to prevent a reduction in the brightness of the entire display screen due to an increase in the number of sub-pixels divided from one display pixel, as compared with the general liquid crystal display device having only the R, G, and B colored layers.

The R, G, B, and C colored layers 6R, 6G, 6B, and 6C of the color filter substrate 92 can be replaced with the following four colored regions.

The four colored regions are composed of a region colored in a shade of blue, a region colored in a shade of red, and two regions colored in two colors selected from the color range from blue to yellow, among a visible light range (380 to 780 nm) where colors vary according to wavelengths. In this case, a shade of blue includes, for example, celadon green and bluish green as well as blue. A shade of red includes, for example, orange as well as red. Each of the colored regions may be composed of a single colored layer, or it may be composed of a laminated structure of a plurality of different colored layers. The colors of the colored regions are obtained by suitably varying chroma and brightness.

More specifically, for example, the region colored in a shade of blue has one selected from the color range from celadon green to bluish green, more particularly, the color range from deep blue to blue. The region colored in a shade of red has one selected from the color range from orange to red. The region colored in one selected from the color range from blue to yellow has one within the color range from blue to green, more particular, from bluish green to green. The region colored in another selected from the color range from blue to yellow has one color within the color range from green to orange, more particular, from green to yellow. Alternatively, the region colored in another selected from the color range from blue to yellow has one color within the color range from green to yellowish green. The colored regions have different colors. For example, when a shade of green is used for two colored regions colored in two colors selected from the color range of blue to yellow, one region is colored in green, and the other region is colored in a shade of blue or yellowish blue. In this way, it is possible to obtain wider color reproducibility, as compared with the conventional R, G, and B colored regions.

Next, the wavelengths of light passing through the four colored regions will be described. The peak wavelength of light passing through the region colored in a shade of blue is in the range of 415 to 500 nm, more preferably, 435 to 485 nm. The peak wavelength of light passing through the region colored in a shade of red is larger than 600 nm, more preferably, 605 nm. The peak wavelength of light passing through the region colored in one color selected from the color range from blue to yellow is in the range of 485 to 535 nm, more particularly, 495 to 520 nm. The peak wavelength of light passing through the region colored in another color selected from the color range from blue to yellow is in the range of 500 to 590 nm, preferably, 510 to 585 nm, and, more preferably, in the range of 530 to 565 nm.

The four colored regions are shown in an xy chromaticity diagram. The region colored in a shade of blue is positioned in an area of x≦0.151 and y≦0.056, more preferably, 0.134≦x≦0.151 and 0.034≦y≦0.056 in the xy chromaticity diagram. The region colored in a shade of red is positioned in an area of 0.643≦x and y≦0.333, more preferably, 0.643≦x≦0.690 and 0.299≦y≦0.333. The region colored in one color selected from the color range from blue to yellow is positioned in an area of x≦0.164 and 0.453≦y, more preferably, 0.098≦x≦0.164 and 0.453≦y≦0.759. The region colored in another color selected from the color range from blue to yellow is positioned in an area of 0.257≦x and 0.606≦y, more preferably, 0.257≦x≦0.357 and 0.606≦y≦0.670.

The four colored regions are configured as follows:
(1) The four regions are colored in red, blue, green, and cyan (bluish green);
(2) The four regions are colored in red, blue, green, and yellow;
(3) The four regions are colored in red, blue, deep green, and yellow, or red, blue, emerald, and yellow; and
(4) The four regions are colored in red, blue, deep green, and yellowish green, or red, bluish green, deep green, and yellowish green

R, G, and B image signals may be directly input to the liquid crystal display device 100 according to the first embodiment from the outside. Alternatively, the R, G, and B image signals input from the outside may be converted into R, G, B, and C image signals, and the converted image signals may be input to the liquid crystal display device 100. In this case, the liquid crystal layer of the W sub-pixel SG always transmits light.

Next, the conversion of the R, G, and B image signals into the R, G, B, and C image signals in the liquid crystal display device 100 will be described below.

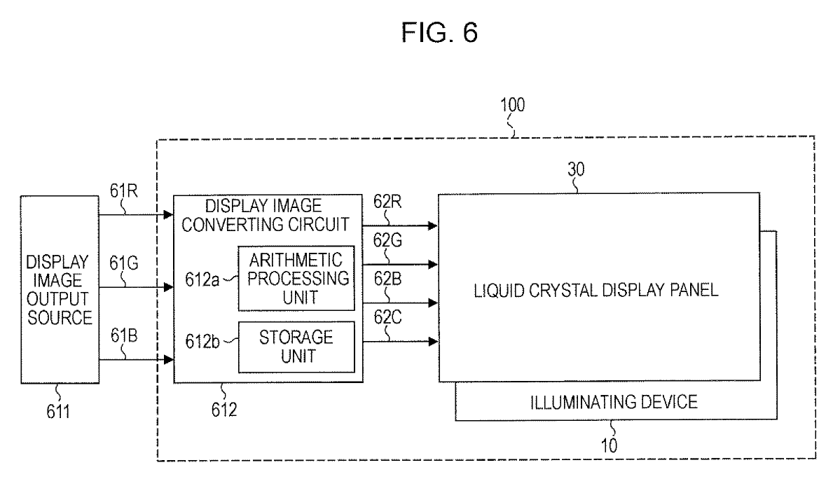

FIG. 6 is a diagram schematically illustrating the liquid crystal display device 100 according to the first embodiment. The liquid crystal display device 100 includes a display image converting circuit 612 to convert R, G, and B image signals into R, G, B, and C image signals. The display image converting circuit 612 converts R, G, and B image signals output from an external display image output source 611, such as a personal computer, into R, G, B, and C image signals, and outputs the converted image signals to the liquid crystal display panel 30.

The display image converting circuit 612 includes an arithmetic processing unit 612a, such as a central processing unit (CPU), and a storage unit 612b, such as a random access memory (RAM). The arithmetic processing unit 612a converts R, G, and B image signals 61R, 61G, and 61B of an input image output from the display image output source 611 into R, G, B, and C image signals 62R, 62G, 62B, and 62C. The storage unit 612b is provided with a look up table (LUT) where R, G, and B image signals having predetermined intensities are associated with R, G, B, and C image signals having intensities corresponding to the predetermined intensities. For example, when R, G, and B image signals capable of displaying cyan (C), for example, R, G, and B image signals having intensities R=0, G=100, and B=100 are input to the arithmetic processing unit 612a, the arithmetic processing unit 612a acquires R, G, B, and C image signals having intensities (for example, R=0, G=10, B=10, and C=100) corresponding to the intensities of the R, G, and B image signals from the LUT of the storage unit 612b, and outputs the acquired R, G, B, and C image signals to the liquid crystal display panel 30. In this way, cyan (C) as well as R, G, and B can be displayed on the display screen of the liquid crystal display panel 30. Therefore, even when R, G, and B image signals are input as image signals of an input image, it is possible to widen the color reproduction range of an output image to the color reproduction range of cyan.

### Second Embodiment

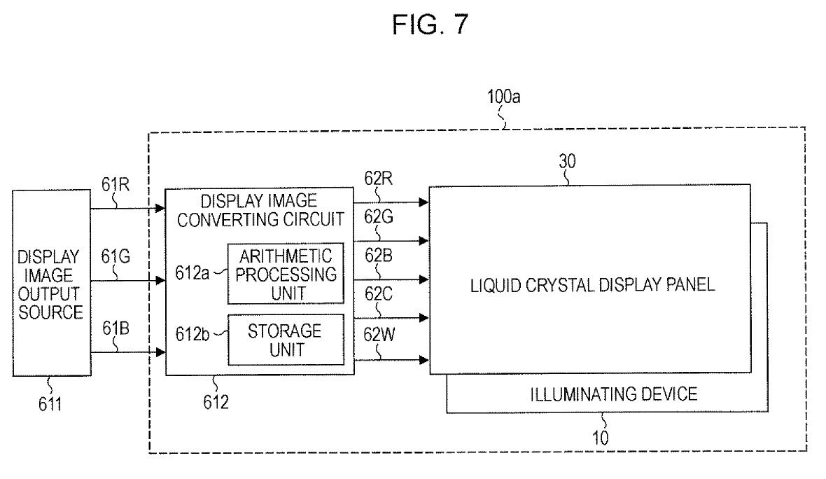

Next, a liquid crystal display device 100a according to a second embodiment of the invention will be described below. FIG. 7 is a diagram schematically illustrating the liquid crystal display device 100a according to the second embodiment. A display image converting circuit 612 of the liquid crystal display device 100a according to the second embodiment converts R, G, and B image signals output from a display image output source 611, such as a personal computer, into R, G, B, C, and W image signals, and outputs the converted image signals to a liquid crystal display panel 30.

Similar to the display image converting circuit described in the first embodiment, the display image converting circuit 612 converts R, G, and B image signals into R, G, B, and C image signals, which makes it possible to widen the color reproduction range. In this case, an arithmetic processing unit 612a calculates a brightness signal on the basis of R, G, and B signals and outputs a W image signal determined on the basis of the brightness signal to the liquid crystal display panel 30. The following Expression 1 is generally used to calculate a brightness signal Y and color difference signals I and Q from the intensities of R, G, and B. In Expression 1, the intensities of R, G, and B are referred to as Ra, Ga, and Ba, respectively. More specifically, the arithmetic processing unit 612a detects the intensities of R, G, and B from the input R, G, and B image signals, and calculates the brightness signal Y from the detected intensities of R, G, and B by using the following Expression 1:
[Expression 1]

$$\{ \begin{matrix}Y = 0.299 Ra + 0.587 Ga + 0.144 Ba \\ I = 0.596 Ra - 0.274 Ga - 0.322 Ba \\ Q = 0.211 Ra - 0.523 Ga - 0.312 Ba\end{matrix} \qquad ( 1 )$$

The arithmetic processing unit 612a determines a W image signal on the basis of the calculated brightness signal Y, and outputs the determined W image signal to the liquid crystal display panel 30. In this way, it is possible to adjust the gray-scale level of the liquid crystal layer of the W sub-pixel SG so as to correspond to an input image and to display an output image with brightness suitable for the input image.

As described above, the liquid crystal display device 100a according to the second embodiment can adjust the gray-scale level of the liquid crystal layer of the W sub-pixel SG on the basis of the brightness signal Y and thus display an output image with brightness suitable for an input image. Therefore, it is possible to improve the color purity of an output image, compared with the structure where light always passes through the liquid crystal layer of the W sub-pixel SG.

### Third Embodiment

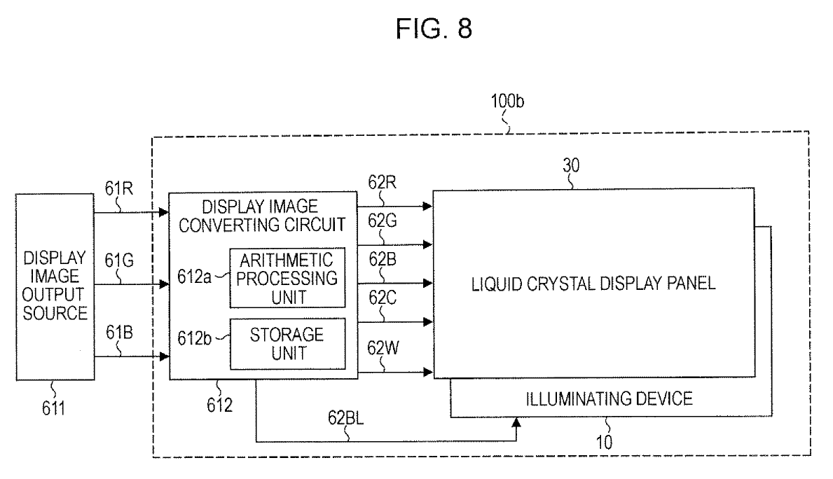

Next, a liquid crystal display device 100b according to a third embodiment of the invention will be described below. FIG. 8 is a diagram illustrating the liquid crystal display device 100b according to the third embodiment. The liquid crystal display device 100b according to the third embodiment differs from the liquid crystal display device 100 according to the first embodiment in that a display image converting circuit 612 supplies a control signal 62BL to an illuminating device 10. More specifically, the display image converting circuit 612 supplies the control signal 62BL to an LED 13 of the illuminating device 10 to adjust the brightness of light L emitted from a light source unit 12 of the illuminating device 10.

An arithmetic processing unit 612a of the display image converting circuit 612 determines the control signal 62BL on the basis of a brightness signal Y obtained by Expression 1. For example, when it is determined that display pixels having high brightness account for a large percentage of one display image on the basis of the brightness signal Y, adjustment is performed to raise the brightness of the light L. On the other hand, when it is determined that display pixels having low brightness account for a large percentages of one display image, adjustment is performed to lower the brightness of the light L. In this case, the liquid crystal layer of the W sub-pixel SG may transmit all light components, or the gray-scale of the liquid crystal layer of the W sub-pixel SG may vary on the basis of the brightness signal Y, as described in the liquid crystal display device 100a according to the second embodiment.

In the liquid crystal display device according to the third embodiment, the brightness of the light L emitted from the illuminating device 10 is adjusted so as to correspond to an input image signal, which makes it possible to display a bright image to be brighter and a dark image to be darker. In this way, it is possible to improve the contrast of the entire display screen.

### Modifications

Next, modifications of the liquid crystal display devices 100 to 100b according to the first to third embodiments will be described below. More specifically, modifications of the arrangement of the sub-pixels SG in the display pixel AG will be described below.

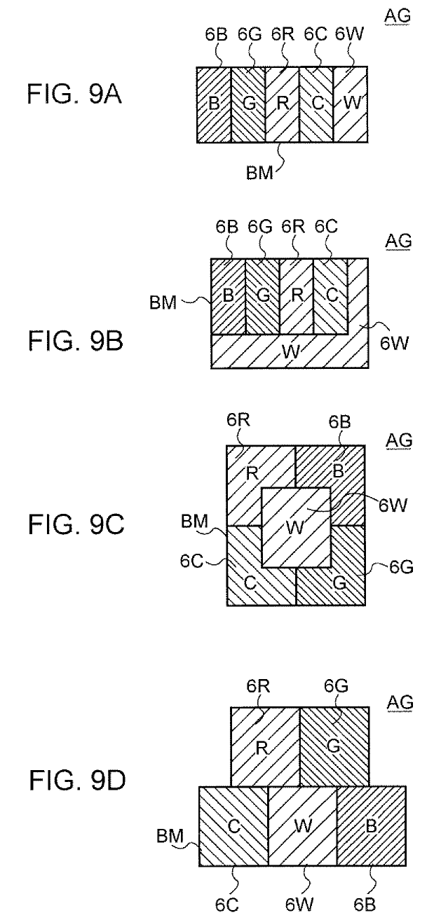

FIGS. 9A to 9D are plan views illustrating the modifications of the arrangement of the sub-pixels SG in the display pixel AG. In FIGS. 9A to 9D, hatched regions indicate R, G, B, and C sub-pixels SG. FIG. 9A shows the arrangement of the sub-pixels SG. The arrangement of the sub-pixels SG in one display pixel AG is not limited to that shown in FIG. 9A, but the sub-pixels SG may be arranged in one display pixel AG as shown in FIGS. 9B to 9D.

In the arrangement shown in FIG. 9B, the W sub-pixel SG has an L shape and comes into contact with the R, G, B, and C sub-pixels SG. Therefore, the arrangement shown in FIG. 9B causes a viewer to see R, G, B, and C with improved brightness. In the arrangements shown in FIGS. 9A and 9B, the R, G, B, C, and W sub-pixels SG are arranged in strip shapes, which makes it possible to simplify the structure of wiring lines, such as the gate lines 33 and the source lines 32, of the liquid crystal display panel 30 for controlling the display state of the sub-pixels.

In the arrangement shown in FIG. 9C, the R, G, B, and C sub-pixels SG are arranged in a check pattern, and the W sub-pixel is arranged at the center of the R, G, B, and C sub-pixels. The arrangement shown in FIG. 9C causes a central portion of the display pixel AG where the W sub-pixel is arranged to appear to be bright. Therefore, as a viewer sees the display pixel AG, the display pixel AG appears to be brighter. A delta arrangement shown in FIG. 9D has the same effects as the arrangements shown in FIGS. 9A to 9C.

In FIGS. 9A to 9D, the area of the W sub-pixel SG may be different from the area of each of the R, G, B, and C sub-pixels. This is because the W sub-pixel is used only to improve the brightness of the display pixel AG. In FIGS. 9A to 9D, the area of the C sub-pixel may be smaller than that of the R, or B sub pixel. In this case, it is possible to prevent green from appearing to be deeper green. In the above-described embodiments, the liquid crystal display panel is used, but the invention is not limited thereto. For example, the invention can be applied to various types of electro-optical devices having display panels, such as an electro-luminescent device, an organic electro-luminescent device, a plasma display device, an electrophoresis display device, and devices using electron emission elements (for example, a field emission display device and a surface-conduction electron-emitter display device).

### Electronic Apparatus

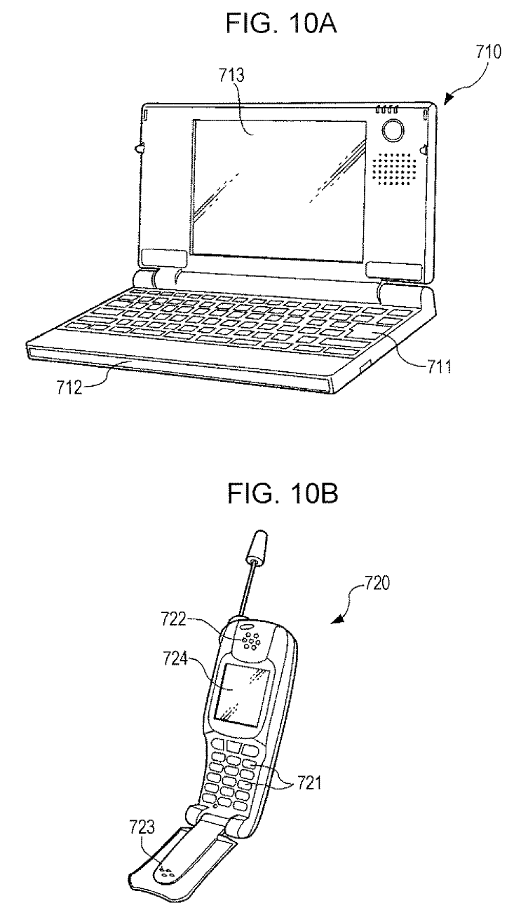

Next, examples of electronic apparatus to which the liquid crystal display devices 100 to 100b according to the above-described embodiments can be applied will be described below with reference to FIGS. 10A and 10B.

First, a portable personal computer (notebook computer) having as a display unit any one of the liquid crystal display devices 100 to 100b according to the above-described embodiments will be described. FIG. 10A is a perspective view showing the structure of the personal computer. As shown in FIG. 10A, a personal computer 710 includes a main body 712 provided with a keyboard 711 and a display unit 713 to which any one of the liquid crystal display devices 100 to 100b according to the above-described embodiments of the invention is applied.

Next, a cellular phone having as a display unit any one of the liquid crystal display devices 100 to 100b according to the above-described embodiments will be described below. FIG. 10B is a perspective view showing the structure of the cellular phone. As shown in FIG. 10B, a cellular phone 720 includes a plurality of operating buttons 721, a receiver 722, a transmitter 723, and a display unit 724 to which any one of the liquid crystal display devices 100 to 100b according to the above-described embodiments is applied.

In addition to the personal computer shown in FIG. 10A and the cellular phone shown in FIG. 10B, the liquid crystal display devices 100 to 100b according to the above-described embodiments of the invention can be applied to various electronic apparatuses, such as a liquid crystal television, a view-finder-type or monitor-direct-view-type videotape recorder, a car navigation apparatus, a pager, an electronic organizer, an electronic calculator, a word processor, a workstation, a videophone, a POS terminal, and a digital still camera.

What is claimed is:

1. An electro-optical device comprising:
a liquid crystal panel that includes display pixels each having a plurality of sub-pixels; and
an illuminating device that illuminates the liquid crystal panel,
wherein the plurality of sub-pixels include at least two sub-pixels including cyan and white sub-pixels.

2. The electro-optical device according to claim 1,
wherein the plurality of sub-pixels further include red, blue, and green sub-pixels.

3. An electro-optical device comprising:
a liquid crystal panel that includes display pixels each having a plurality of sub-pixels; and
an illuminating device that illuminates the liquid crystal panel,
wherein at least two of the plurality of sub-pixels have regions colored in two colors selected from a color range from blue to yellow, and
at least one of the plurality of sub-pixels has a region that transmits light without coloring.

4. The electro-optical device according to claim 3,
wherein the plurality of sub-pixels further include a sub-pixel having a region colored in a shade of blue and a sub-pixel having a region colored in a shade of red.

5. The electro-optical device according to claim 3,
wherein one of the two sub-pixels has a region colored in one color selected from a color range from blue to green, and the other sub-pixel has a region colored in one color selected from a color range from green to orange.

6. An electro-optical device comprising:
a liquid crystal panel that includes display pixels each having a plurality of sub-pixels; and
an illuminating device that illuminates the liquid crystal panel,
wherein the plurality of sub-pixels include a sub-pixel having a colored region that transmits light having a peak wavelength of 485 to 535 nm, a sub-pixel having a colored region that transmits light having a peak wavelength of 500 to 590 nm, and a sub-pixel having a region that transmits light without coloring.

7. The electro-optical device according to claim 6,
wherein the plurality of sub-pixels further include a sub-pixel having a colored region that transmits light having a peak wavelength of 415 to 500 nm and a sub-pixel having a colored region that transmits light having a peak wavelength larger than 600 nm.

8. The electro-optical device according to claim 6, further comprising:
a display image converting circuit that converts input image signals into image signals corresponding to the plurality of sub-pixels.

9. The electro-optical device according to claim 8,
wherein the display image converting circuit calculates a brightness signal from the input image signal and determines an image signal corresponding to the sub-pixel having the region that transmits the light without coloring, on the basis of the brightness signal.

10. The electro-optical device according to claim 8,
wherein the display image converting circuit determines the brightness of the illuminating device on the basis of the brightness signal and adjusts the brightness of the illuminating device.

11. An electronic apparatus comprising as a display unit the electro-optical device according to claim 6.
